(19) United States
(12) Patent Application Publication
(10) Pub. No.: US 2016/0208984 A1
(43) Pub. Date: Jul. 21, 2016

(54) LIQUEFIED GAS FILLING STATION COMBINED WITH A LIQUEFIED GAS PRODUCTION DEVICE

(71) Applicant: CRYOSTAR SAS, Hesingue (FR)

(72) Inventor: GUILLAUME PAGES, Huningue (FR)

(21) Appl. No.: 14/913,015

(22) PCT Filed: Aug. 6, 2014
(86) PCT No.: PCT/FR2014/052052

§ 371 Date: Feb. 19, 2016

(30) Foreign Application Priority Data
Aug. 21, 2013 (FR) 13 58107

(51) Int. Cl. F17C 5/04; F25J 1/00; F25J 1/02; F17C 13/02

(52) U.S. Cl. CPC F17C 5/04; F17C 13/026; F17C 13/025; F25J 1/0022; F25J 1/0228; F17C 2221/033; F17C 2223/0123; F17C 2225/0161; F17C 2227/0355; F17C 2250/0439; F17C 2250/0626; F17C 2265/063

(57) ABSTRACT

A filling station includes a first circuit (2) with a tank (10) of liquefied gas supplied with gas in the gaseous state, a second circuit (4) with means for compressing a fluid and expanding same, an exchanger (14, 114) between the first circuit (2) and the second circuit (4), means (LT) for determining the level of liquefied gas in the tank (10), a device for measuring the temperature (TT) in the first circuit (2) downstream from the exchanger (14, 114), means (30, 32) for varying the pressure of the fluid in the second circuit (4), and a control system acting on the means for varying the pressure in the second circuit on the basis of the measured temperature and the level of liquefied gas in the tank.

The present invention concerns a filling station combined with a production device for liquefied gas.

The present invention concerns more particularly a filling station intended for example to fill a tank truck which will supply a tank of a service station dispensing liquefied natural gas, and a filling station combined with means of production of liquefied natural gas from gas in the gaseous state.

To fuel vehicles operating on liquefied natural gas, it is known to have a service station able to dispense liquefied natural gas from a tank. The latter is supplied for example from tank trucks which regularly fill the tank.

As is known, a filling station tank is supplied with gas by a supply source of gas in the gaseous state which has been processed in order to be freed of its impurities, in particular. This gas then goes through a heat exchanger to be liquefied. It is then taken to the filling station tank. This tank is likewise, on the one hand, supplied by the source of gas in the gaseous state and an exchanger, and on the other hand liquid gas is withdrawn to fill tanks (of a tank truck or ship, or any other type of liquefied gas tank).

It is also furthermore known how to use an exchanger, or condenser, which is part of a thermodynamic circuit, also known as a liquefier, to cool a gas. In the liquefier, a fluid is compressed and then expanded to produce cold. The temperatures obtained are well below −160° C. To avoid large temperature variations, it is preferable for the liquefier to have a continuous duty. It is also possible to shut down the liquefier, but to preserve its various components one needs to schedule several hours for such a shutdown. Likewise, the placing of the liquefier in service is a long operation taking several hours.

Thus, on the one hand there is a liquefier which produces cold, preferably in continuous duty, and on the other hand a filling station which “consumes” the liquefied natural gas produced by the liquefier in highly irregular manner, depending on the arrival of the tanks being filled. When the flow rate of liquefied natural gas leaving the tank of the filling station is relatively high and several tanks need to be filled every day, one can adapt the production of cold of the liquefier to meet the needs for liquefied natural gas of the filling station. On the other hand, when the flow rate of the filling station is relatively low, for example, when it happens that no filling of a tank will occur for twenty four hours straight, it is hard to manage between the production of liquefied gas and the outgoing flow rate.

For such stations of irregular and/or low flow rate, it is at times necessary to halt the production of cold and thus the liquefier. The shutdowns and resumptions of operation are then handled manually by an operator in charge of the management of the filling station.

Thus, the purpose of the present invention is to provide a filling station combined with a liquefier for which the production and the storage of liquefied (natural) gas is done automatically.

Another goal of the present invention is to provide such a station which is able to run without having to halt the operation of the liquefier associated with the filling station.

For this purpose, the present invention proposes a station for filling of liquefied gas and production of liquefied gas, having:

a first circuit with a tank of liquefied gas supplied with gas in the gaseous state by a gas supply line,

a second circuit of refrigerant fluid fluidically independent of the first circuit with means for compressing and expanding this fluid, and

a heat exchanger between the first circuit and the second circuit, the heat exchange being carried out upstream from the tank.

According to the present invention, such a station further comprises:

means for determining the level of liquefied gas in the tank,

a device for measuring the temperature in the first circuit, downstream from the exchanger and upstream from the tank,

additional means of varying the pressure of the fluid within the second circuit of fluid, and

a command and control system acting on the means of varying the pressure in the second circuit as a function of the temperature measured by the temperature measurement device and as a function of the level of liquefied gas in the tank.

A station according to the present invention can automatically produce a liquefied gas especially thanks to the implementing of a liquefier (second circuit with its exchanger) in which the pressure of the refrigerant fluid is modifiable and has an original regulation based, on the one hand, on the level in the tank and on the temperature of the liquefied gas at a point between the exchanger and the tank, and on the other hand based on an action on the pressure of the refrigerant fluid in the liquefier. One thus combines a system for production of liquefied gas providing different operating modes (with preferably one mode corresponding to a slowed down operating mode) with an original system of regulation enabling an automated running.

Means can also be provided in the second circuit of a filling station as described above for cooling the fluid after its compression and before its expansion. One can provide several steps of compression and cooling, such as three successive steps, followed by an expansion.

The layout of the second circuit is for example such that it furthermore has means of circulating its refrigerant fluid in the exchanger after its expansion of its refrigerant fluid and of bringing it back to the compression means in order to achieve a closed cycle. If several steps of compression, cooling and expansion are provided, the refrigerant fluid is preferably brought to the first compression stage after reheating in the heat exchanger.

To enable the regulation of the pressure in the second circuit of fluid, the latter comprises for example a fluid storage tank having, on the one hand, a fluid inlet supplied by a pilot valve situated downstream from the means for compression of the fluid, and on the other hand a fluid outlet controlled by a pilot valve enabling an injecting of the fluid contained in the fluid storage tank into the second circuit upstream from the means of compression of the fluid. The second circuit can then be a closed circuit.

The fluid used in the second circuit is advantageously nitrogen, which is perfectly suited as a refrigerant fluid of a pressure-modulated circuit.

The first circuit advantageously comprises a pressure regulating valve situated upstream from the exchanger. This valve makes it possible to adjust the pressure of the gas in the first circuit in order to avoid excess pressure. It also makes it possible to cut off the arrival of gas, which may be needed in certain particular conditions.

An advantageous embodiment of the present invention calls for the system being such that the first circuit and the second circuit have a single exchanger in which the fluid of the second circuit circulates in a first direction after expansion and in a second direction there circulates, on the one hand, the fluid of the second circuit downstream from the means for compression of the fluid and upstream from the expansion means and on the other hand the gas of the first circuit, this gas entering the exchanger in the gaseous state and leaving it in the liquid state. This makes it possible to limit the number of components without thereby harming the performance of the system as a whole.

To regulate a system according to the invention, one provides for example that the command and control system acts on the means of varying the pressure in the second circuit as a function of the temperature measured by the temperature measurement device and as a function of the level of liquefied gas in the tank.

One variant embodiment of the system has a pilot valve situated between the temperature measurement device and the tank. In this variant embodiment, one can provide that, for the regulation of said system, the command and control system has a first control loop by which the pilot valve situated between the temperature measurement device and the tank is controlled by the level of liquid in the tank as well as a second control loop by which the pressure in the second circuit is controlled by the temperature measured by the temperature measurement device.

### BRIEF DESCRIPTION OF THE DRAWINGS

Details and advantages of the present invention will better appear from the following description, making reference to the enclosed schematic drawings, in which:

FIG. 1 illustrates schematically a first embodiment of the present invention, and

FIGS. 2 to 4 are views similar to that of FIG. 1 for variant embodiments.

### DETAILED DESCRIPTION OF THE INVENTION

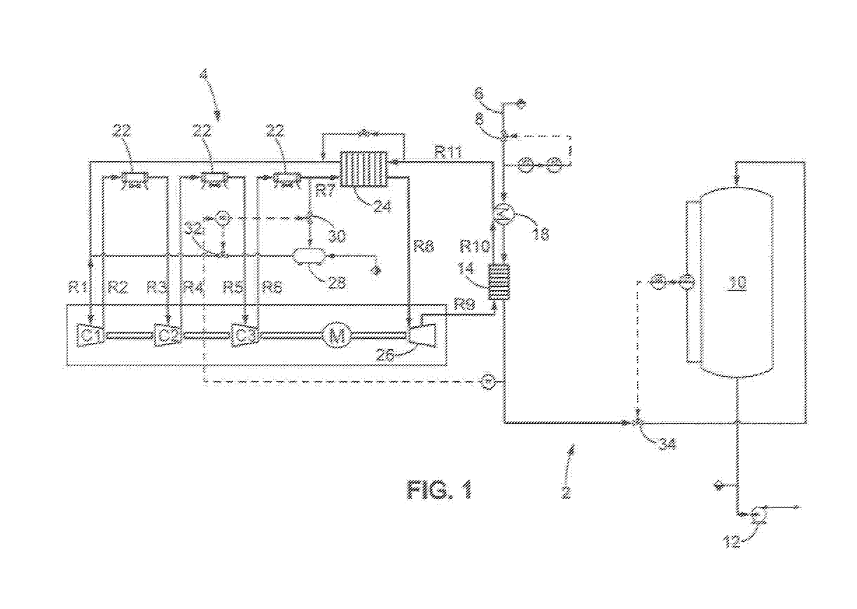

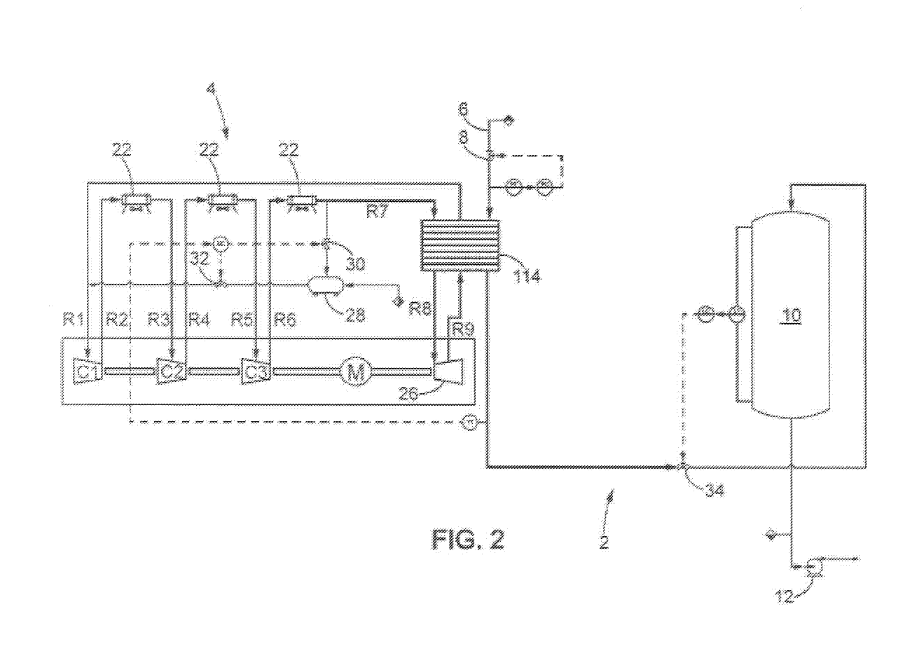

One sees in FIG. 1 (and in FIGS. 2 to 4) a first circuit 2 at the right and a second circuit 4 at the left.

In all of the following description, the gas circulating in the first circuit is natural gas, in the gaseous or liquid state, and the fluid used in the second circuit is nitrogen (N₂) which remains in the gaseous state. However, the invention can be applied to a liquefied gas other than natural gas and the refrigerant fluid used in the second circuit can be other than nitrogen.

The first circuit has a natural gas inlet 6 with pressure regulated by a pressure regulating valve 8 designed to supply a tank 10. The natural gas arrives in the gaseous state in the area of the inlet 6 and then is liquefied before arriving in the tank 10. A pump 12 is used for example to draw off liquefied natural gas from the tank 10 in order to fill a tank of a tank truck or aboard a ship, a ship tank, etc.

The gas in the area of the inlet 6 is presumed to have been treated. If not, a treatment unit (not shown) can be provided, which performs a purification of the gas for example by absorption or preferably by adsorption. The gas entering the first circuit 2 can come, for example, from a pipe main or from a biogas production unit or digester.

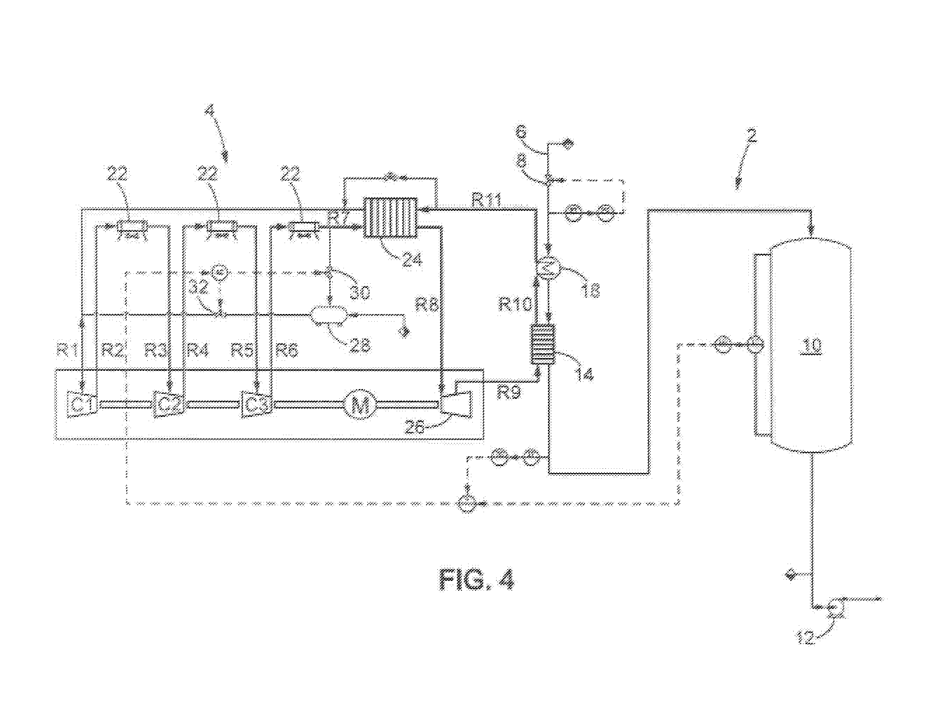

The second circuit forms a system of combined compression and expansion known hereafter as a liquefier. In particular, it comprises a condenser 14 likewise in connection with the first circuit 2 and designed to provide for the liquefaction of the natural gas in this circuit. One also notes in FIGS. 1 and 4 the presence of a desuperheater 18 between the first circuit 2 and the second circuit 4. This desuperheater 18 enables a first cooldown of the natural gas coming from the inlet 6 before it is introduced into the condenser 14 where it will be liquefied and then stored in the tank 10. The second circuit 4 here is a closed circuit.

In the liquefier, a motor M drives three compressors C1, C2 and C3, each one forming a stage of a compression unit. In the following description of the liquefier, we propose to follow the nitrogen which is moving in this circuit.

The nitrogen arrives in the compressor C1 by a line R1 and leaves by a line R2. It then arrives at a first cooler 22 in order to control the temperature of the nitrogen before being sent to the compression unit C2 by a line R3. The nitrogen is then compressed by the second compressor C2, then brought by R4 to a second cooler 22 and reaches by R5 a third stage of compression of the compression unit C3. A third cooler 22, connected to the third compressor C3 by a line R6, makes it possible to control the temperature of the nitrogen leaving the compression unit.

A line R7 takes the nitrogen to a countercurrent exchanger 24 and then it is taken by R8 to an expansion machine 26. This latter is mechanically connected to the motor M and to the compression unit. Upon leaving the expansion machine 26, the nitrogen is then taken by line R9 to the condenser 14 where it absorbs heat from the natural gas which one wants to liquefy in order to obtain liquefied natural gas (LNG). Leaving the condenser 14, the nitrogen is taken by line R10 to the desuperheater 18 before reaching by line R11 the countercurrent exchanger 24 which is connected downstream to the first compressor C1 of the compression unit.

One also finds in the second circuit 4 a nitrogen storage tank 28 which is used to regulate the quantity of nitrogen in the liquefier, and thus the pressure of this nitrogen in the second circuit. The more nitrogen in the second circuit 4 (and thus the less nitrogen in the tank 28), the more elevated the pressure in the second circuit 4 and likewise the more elevated the number of calories which can be extracted from the natural gas to enable its liquefaction.

To fill the tank 28, one will withdraw nitrogen from a portion of the second circuit 4 where the pressure is elevated, for example, at the outlet of the compression unit, preferably after the last cooler 22. An inlet valve 30 is used to perform such a withdrawal.

In similar fashion, in order to reintroduce nitrogen into the second circuit 4, and thus partially (or totally) empty the tank 28, an outlet valve 32 connects an outlet of the tank 28 to a portion of the second circuit where the pressure is low, preferably just upstream from the compression unit and its first compressor C1.

In the embodiment of FIGS. 1 and 2, the first circuit 2 has a filling valve 34 which regulates the flow of liquefied natural gas entering the tank 10 and which is situated downstream from the condenser 14 and of course upstream from the tank 10.

The purpose of the present invention is to regulate the filling of the tank 10 as a function of the withdrawals made from this tank by the pump 12.

For this, the embodiment of FIGS. 1 and 2 calls for continual checking of the level of liquid in the tank 10 and measuring of the temperature downstream from the condenser 14. The checking of the level in the tank 10 is done by sensors LT which are known to the skilled person and which are classically used to perform a measurement of level in a tank of liquefied natural gas. These sensors LT are connected to a microcontroller LC which processes the information furnished by the sensors LT.

In the embodiment of FIGS. 1 and 2, the microcontroller LC likewise provides a directional control of the filling valve 34. One thus achieves a first control loop in the management of the level of liquid in the tank 10.

The temperature measurement is done by a sensor TT which in turn is connected to a microcontroller XC. This latter, using the information regarding the temperature in the first circuit 2 downstream from the condenser 14 acts on the inlet valve 30 and on the outlet valve 32 to adapt the quantity of nitrogen in the second circuit 4. When the temperature measured by the sensor TT drops, the microcontroller XC will have a tendency, according to a predetermined control law, to once more open the inlet valve 30 so as to remove nitrogen from the second circuit 4. Due to this fact, the absorption of calories from the natural gas, and thus also the production of liquefied natural gas, is limited. In this way, a second control loop is created.

The two control loops are connected. In fact, by acting on the filling valve 34, one causes a variation in the temperature measured by the sensor TT. If, given a continuous state of flow of liquefied natural gas from the condenser 14 to the tank, the filling valve 34 is opened, the liquefied natural gas produced in the area of the condenser 14 will then fill the tank 10 more quickly and the temperature measured by the sensor TT will rise. Conversely, if the filling valve 34 is closed, the liquefied natural gas has a tendency to accumulate upstream from the tank 10 and the temperature measured by the sensor TT will decrease. Thus, there is a physical interaction between the two regulation loops.

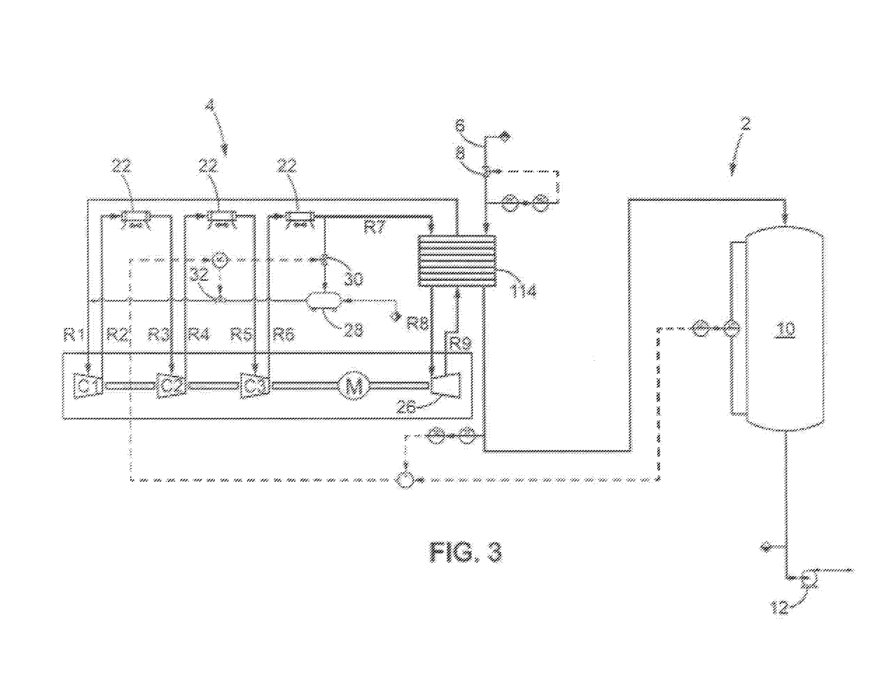

In the variant embodiments of FIGS. 3 and 4, one again finds the sensors of level LT and the associated microcontroller LC as well as the temperature sensor TT. The value measured by the temperature sensor is digitized by a microcontroller TC and the information obtained by the level and temperature sensors and then processed by the microcontrollers LC and TC is collected and analyzed by the microcontroller XC which is provided to act on the inlet valve 30 and the outlet valve 32 of the second circuit 4.

In this embodiment, the filling valve 34 provided in the variant embodiments of FIGS. 1 and 2 can be omitted. The regulation presented here in fact also enables a regulating of the entire system. The analysis of the level in the tank lets one find out the consumption of liquefied natural gas and the temperature reading downstream from the condenser 14. The mere regulation of the nitrogen pressure in the second circuit 4 makes it possible to check the production of liquefied natural gas within the condenser 14. In fact, the quantity of liquefied gas through the condenser depends on the calories absorbed by the gas entering into the first circuit 2 by the inlet 6. By limiting the nitrogen pressure in the second circuit 4, one limits the calories absorbed in the area of the condenser 14 (and possibly in the area of the desuperheater 18) and thus the production of liquefied gas.

In all the embodiments, one notes the presence as well of a control loop at the inlet of the first circuit 2. This regulation is a typical regulation at a gas inlet to regulate the pressure in the circuit and prevent excess pressure which might be damaging. Furthermore, the regulation of this pressure makes it possible to adjust the pressure in the condenser to a setpoint value. This regulation can also be useful, for example, when the level in the tank is high and one wishes to reduce the production of liquefied natural gas in order to avoid saturating the condenser with gas in the liquid state.

The variant embodiments of FIGS. 2 and 3 call for limiting the number of heat exchangers and regrouping the condenser 14, the desuperheater 18 and the countercurrent exchanger 24 into a single exchanger/condenser 114. In the embodiment illustrated in FIGS. 2 and 3, the single exchanger/condenser 114 has a central channel extending in one direction and two lateral channels going in the opposite direction. The central channel is occupied by the nitrogen leaving the expansion machine 26 and before entering the compression unit. One lateral channel is occupied by the nitrogen which is cooled after having been compressed in the compression unit and before its expansion, while the other lateral channel is occupied by the gas entering the exchanger/condenser 114 in the gaseous state and leaving in the liquid state.

The exchanger/condenser 114 can be, for example, a brazed aluminum plate exchanger. The condenser 14 and/or the countercurrent exchanger 24 can also be exchangers of this type.

The different embodiments described above and illustrated in the enclosed drawing make it possible to produce liquefied natural gas (or another liquefied gas) automatically and store it without having to set running and halt the running of the associated liquefier.

The refrigeration cycle integrates a cryogenic nitrogen expansion machine which can be regulated by varying the pressure of the nitrogen in the cycle. Such refrigeration devices enable a slowed down operation which here makes it possible to halt the production of liquefied natural gas without having to halt the refrigeration cycle. The components of the device are maintained at temperature and thus can be used afterwards to switch to the production mode for liquefied gas.

In normal operating mode, natural gas enters the system and is liquefied, then stored in the tank. A management of the level in the tank makes it possible to adapt the production of liquefied natural gas to the needs for liquefied natural gas corresponding to the flow rate of LNG from the tank.

Of course, the present invention is not limited to the preferred embodiments described above and illustrated in the drawing as nonlimiting examples. It also pertains to all variant embodiments within the ability of the skilled person in the context of the following claims.

1-11. (canceled)

12. A station for filling of liquefied gas and production of the liquefied gas, comprising:
a first circuit (2) having a gas storage tank (10) of the liquefied gas supplied during use with a gas in a gaseous phase from a gas supply line;
a second circuit (4) of refrigerant fluid fluidly independent of the first circuit, the second circuit including compressing means and expanding means, each of said compressing and expanding means respectively arranged to compress and expand the refrigerant fluid;
a heat exchanger (14, 114) arranged between the first circuit (2) and the second circuit (4) for providing heat exchange upstream from the gas storage tank (10);
a liquid level sensor (LT) for determining a level of the liquefied gas in the gas storage tank (10);
a temperature measuring device (TT) for measuring a temperature in the first circuit (2) downstream from the heat exchanger (14, 114) and upstream from the gas storage tank (10);
pressure variation means (30, 32) for varying a pressure of the refrigerant fluid within the second circuit (4); and
a command and control system arranged to act on the pressure variation means (30, 32) to vary the pressure in the second circuit (4) as a function of the temperature measured by the temperature measuring device (TT) and as a function of the level of the liquefied gas in the gas storage tank (10).

13. The station according to claim 12, wherein the second circuit (4) comprises means for cooling the refrigerant fluid after compression and before expansion of said refrigerant fluid.

14. The station according to claim 13, wherein the compressing means and the cooling means are arranged for action on the refrigerant fluid three times in succession and for expanding said refrigerant fluid.

15. The station according to claim 12, wherein the second circuit further comprises means for circulating the refrigerant fluid in the heat exchanger (14, 114) after expansion and returning said refrigerant fluid to the compression means in a closed cycle.

16. The station according to claim 12, wherein the second circuit (4) further comprises a refrigerant fluid storage tank (28) including a fluid inlet supplied by a first pilot valve (30) positioned downstream from the compression means, and a fluid outlet controlled by a second pilot valve (32) for injecting the refrigerant fluid contained in the refrigerant fluid storage tank (28) into the second circuit (4) upstream from the compressing means.

17. The station according to claim 12, wherein the refrigerant fluid in the second circuit (4) comprises nitrogen.

18. The station according to claim 12, wherein the first circuit (2) comprises a pressure regulating valve (8) positioned upstream from the heat exchanger (14, 114).

19. The station according to claim 12, wherein the first circuit (2) and the second circuit (4) are each arranged for fluid communication with a single heat exchanger (114), from which the refrigerant fluid of the second circuit (4) circulates in a first direction after expansion, and in a second direction circulates downstream from the compressing means and upstream from the expanding means and the liquefied gas of the first circuit (2) enters the single heat exchanger (114) in the gaseous phase and exits in a liquid phase.

20. The station according to claim 12, wherein the command and control system acts on the pressure variation means to control the pressure in the second circuit (4) as a function of the temperature measured by the temperature measuring device (TT) and as a function of the level of the liquefied gas in the gas storage tank.

21. The station according to claim 12, further comprising a pilot valve (34) arranged between the temperature measuring device (TT) and the gas storage tank (10).

22. The station according to claim 21, wherein the command and control system comprises:
a first control loop by which the pilot valve (34) arranged between the temperature measuring device (TT) and the gas storage tank (10) is controlled by the level of the liquefied gas in said gas storage tank (10); and
a second control loop which controls the pressure in the second circuit (4) by the temperature measured by the temperature measuring device (TT).
